(19) United States
(12) Patent Application Publication
(10) Pub. No.: US 2004/0225573 A1
(43) Pub. Date: Nov. 11, 2004

(54) Methods and apparatus for anonymously transacting internet shopping and shipping

(76) Inventor: Marvin T. Ling, Scottsdale, AZ (US)

Correspondence Address: Nicola A. Pisano, Esq., 11988 El Camino Real, Suite 200, San Diego, CA, 92130, US

(21) Appl. No.: 10/434,886

(22) Filed: May 9, 2003

(51) Int. Cl. G06F 17/60

(52) U.S. Cl. 705/26

(57) ABSTRACT

Systems and methods are provided for supporting electronic commerce in an environment in which the service provider has vendors, shipping companies and users registered with its system so that a user can purchase goods and services from a participating vendor's website and have the vendor ship the purchased products to the user without disclosing to the vendor any personal information including shipping address.

### FIELD OF THE INVENTION

This application relates to electronic commerce systems and, more particularly, to systems for facilitating electronic commerce in environments with users who prefer to maintain their privacy. More particularly, the present invention is directed to methods and apparatus for facilitating electronic commerce for users who prefer to remain anonymous.

### BACKGROUND OF THE INVENTION

On-line vendors sell a variety of products over the Internet. Users may browse a vendor's website and may purchase products directly from the vendor. Typically the user will be required to divulge sensitive financial information, such as by identifying a credit card to consummate a purchase, and sensitive personal information, such as the user's home address, to receive delivery of the purchased item. While the majority of on-line vendors conduct reputable businesses with sound business practices concerning customer information, concerns about misuse of sensitive information continue to restrain growth in electronic commerce.

In addition to the potential for misuse by unscrupulous vendors, many websites notify customers that certain information, such as e-mail or residence address information, may be compiled and sold to other vendors whose products may be of interest to users. Consequently, users may unwittingly become inundated by direct marketing literature sent to their residence addresses, or worse, by direct telephone solicitations. Accordingly, it would be desirable to develop methods and systems that enable a user to freely transact on-line business, while disclosing sensitive personal or financial information to only a few trusted companies.

Internet service providers, e.g., those associated with portal sites, have attempted to capitalize on their large established user bases by establishing on-line shopping services. These services enable registered users to shop at multiple vendor websites without having to establish individual accounts at each vendor. Instead, a user establishes a single account with the service provider. The service provider then debits that account for purchases made by the user at vendors associated with that service provider, so that the user's sensitive financial information need not be disclosed to the individual vendors. In such previously known arrangements, however, the user is required to disclose his or her residence or business address to actually receive delivery of the goods or services ordered on-line.

In view of this drawback of previously known on-line shopping arrangements, it would be desirable to develop methods and apparatus in which the user's personal information, e.g., identity and shipping information, as well as the user's sensitive financial information, could be screened from the vendors.

It further would be desirable to provide methods and apparatus by which a trusted service provider could maintain a user's personal information, such as identity and shipping information, so that the user's personal information need not be disclosed to individual on-line vendors.

It also would be desirable to provide methods and apparatus that enable a user to shop on-line at multiple vendor sites, and to make payments for, and receive shipments of, products anonymously.

It yet further would be desirable to provide methods and apparatus that enable a user to shop on-line at multiple vendor sites, and to make payments for, and receive shipments of, products without having to establish an account at each of the vendor websites.

### SUMMARY OF THE INVENTION

In view of the foregoing, it is an object of the present invention to provide methods and apparatus in which the user's personal information, e.g., identity and shipping information, as well as the user's sensitive financial information, can be screened from the vendors from whom the user makes purchases.

It is a further object of this invention to provide methods and apparatus by which a trusted service provider maintains a user's personal information, such as identity and shipping information, so that the user's personal information need not be disclosed to individual on-line vendors.

It is also an object of this invention to provide methods and apparatus that enable a user to shop on-line at multiple vendor sites, and to make payments for, and receive shipments of, products anonymously.

It is yet another object of the present invention to provide methods and apparatus that enable a user to shop on-line at multiple vendor sites, and to make payments for, and receive shipments of, products without having to establish an account at each of the vendor websites.

These and other objects of the present invention are accomplished by providing methods and apparatus in accordance with which a service provider's computer maintains database information on users who wish to make purchases anonymously, and vendors and shipping companies that are associated with the service provider and wish to participate in the program.

Information stored in the service provider's user database may include the user's personal information, login information, password, financial information, contact information and shipping information. The service provider's vendor database may include information on participating vendors, such as the vendor name, vendor account information, vendor address and vendor shipping or pickup locations. The service provider's shipping company address may include similar information on participating shipping companies, such as the shipping company name, account information, address and pickup or shipping locations and schedules.

In accordance with the principles of the present invention, the service provider computer records and maintains data regarding purchase transactions by the user, and debits the user's account for purchases made and shipping costs associated with those purchases. The service provider computer also may credit participating vendors accounts for the amounts of purchases made by the user, less any service charge due to the service provider for administering the anonymous shipping program.

Likewise, the service provider computer also may credit the accounts of participating shipping companies for the shipping charges associated with the user's purchases, less any service charge due to the service provider for administering the anonymous shipping program.

Further in accordance with the methods of the present invention, the vendor computer sends to the service provider the information regarding a user purchase required to process a transaction. This information includes the total sales price, size and weight of any package that needs to be shipped to the user, and the pickup location where a participating shipper can collect the package.

The service provider computer collects the information sent by the vendor, receives the login information from the user for validation and retrieves the user's shipping address from its database. It then sends the information required by the shipping company to calculate the shipping cost. This information includes the pickup location address, destination address and size and weight of the package.

The shipping company computer collects the information sent by the service provider computer, calculates the shipping cost and sends the shipping cost information back to the service provider computer.

The service provider computer displays the total cost, including sales price plus shipping cost, to the user and asks the user to confirm the purchase. Preferably, the foregoing steps are performed in real time, so that the total cost, including sales price plus shipping cost, are displayed to the user contemporaneously with the proposed purchase transaction. Alternatively, the information may be collected and then returned to the user in a separate communication, e.g., in the form of an e-mail notification.

In either case, once the user confirms the order, the service provider computer debits the user account and credits the vendor and shipping company's accounts. The service provider computer also calculates the royalty and any other service charges that are payable to the service provider by the vendor and the shipping company.

### BRIEF DESCRIPTION OF THE DRAWINGS

Additional features of the invention, its nature and various advantages will be more apparent from the accompanying drawings and the following detailed description of the preferred embodiments, in which:

FIG. 1 is a block diagram of an illustrative system showing the entities involved in transacting business anonymously in accordance with the present invention;

FIGS. 2-4 are illustrative screens presented by a vendor that implement an anonymous shipping option in accordance with the present invention;

FIG. 5 is a flow chart of illustrative steps implementing the anonymous shipping method of the present invention;

FIG. 6 is a flow chart of illustrative steps implementing a first method by which the user pays the cost of anonymous shipping;

FIG. 7 is a flow chart of illustrative steps implementing a first method by which the vendor pays the cost of anonymous shipping;

FIG. 8 is a flow chart of illustrative steps implementing a second method by which the user pays the cost of anonymous shipping;

FIG. 9 is a flow chart of illustrative steps implementing a second method by which the vendor pays the cost of anonymous shipping;

FIG. 10 is a flow chart of illustrative steps that implement a method for handling transactions in which the requested goods or services are out-of-stock; and

FIG. 11 is a flow chart of illustrative steps that implement a method for handling transactions in which goods are to be returned to the seller.

### DETAILED DESCRIPTION OF THE PREFERRED EMBODIMENTS

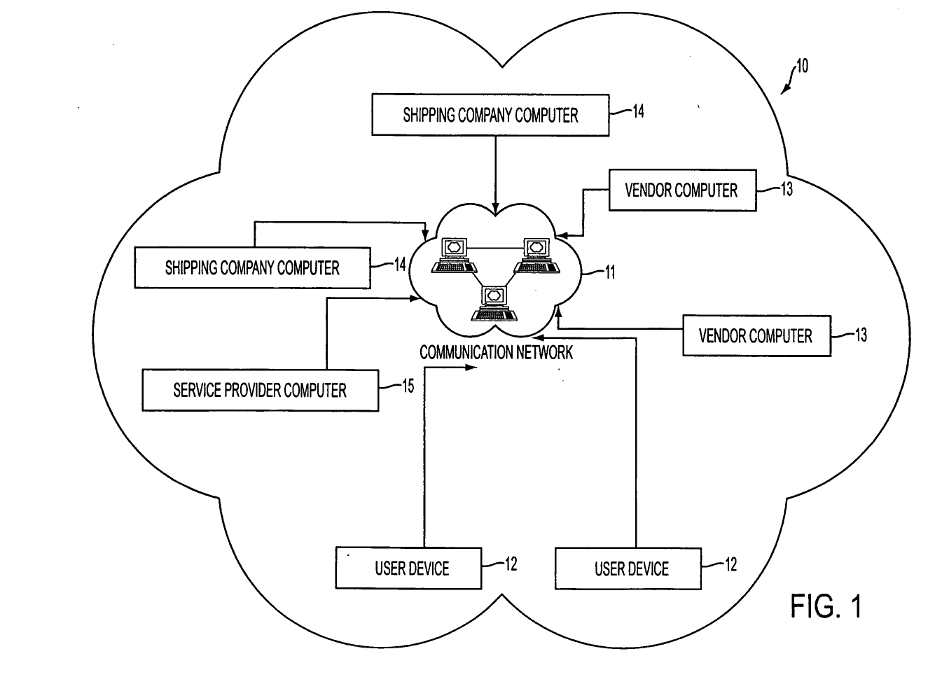

Referring to FIG. 1, illustrative system 10 for supporting electronic commerce in accordance with the principles of the present invention is described. System 10 enables a user to make purchases at participating vendors' websites and request those vendors to ship the purchased products to the user without disclosing the user's personal information or shipping information.

In system 10 of FIG. 1, communications network 11 enables various entities, including one or more users, one or more vendors, one or more shipping companies, and at least one service provider to communicate with one another through respective computers 12, 13, 14 and 15. Preferably, communications network 11 may be Internet-based and may include local area networks, wide area networks, private networks, or any other suitable networks that support communications between different parties located at respective computers or other suitable electronic devices.

User devices 12, such as desktop or notebook personal computers, personal digital assistants, wireless telephones, or any other suitable user devices, enable a user to browse for products at vendor websites on vendor computers 13 over communications network 11. Product offerings on vendor computers 13 may be provided in the form of web pages organized into websites. Internet web browser applications, typically resident on user devices 12, permit users to browse, select and order goods and services from amongst the web content presented on vendor computers 13.

Vendor computers 13 are programmed to provide websites that offer users visiting the vendor's website the opportunity to purchase goods and services. For example, one vendor 13 may sell intangible products such as electronically-downloadable songs or tangible products such as compact discs to be delivered by mail. Another vendor may sell shoes, clothing, books or auto supplies. Yet another vendor may constitute an auction site in which goods or services may be offered for sale by competitive bidding.

Various shipping companies facilitate on-line transactions consummated by users of user devices 12 by transporting goods from locations designated by the vendors to the users. In accordance with the present invention, a selected one of shipping company computers 14 receives information via communication network 11 about a proposed shipping transaction, and processes that information to calculate a shipping cost. The shipping cost data is then relayed to the user via the service provider computer 15 and the communication network 11.

Service providers, who may be in the business of providing Internet connection or portal services, operate service provider computers 15. In accordance with the principles of the present invention, service provider computers may be programmed to facilitate anonymous shopping and shipping transactions, and to maintain transaction records and other databases. In accordance with one aspect of the present invention, the users, vendors and shipping companies all are registered with service provider computer 15.

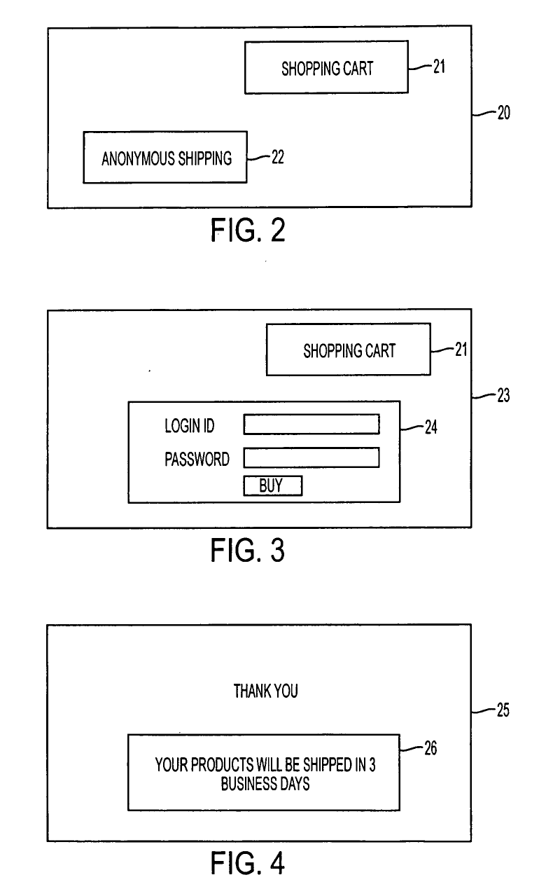

Referring now to FIGS. 2-3, illustrative screen displays that may be displayed by vendor computer 13 and service provider computer 15 to a user engaged in an anonymous shopping and shipping transaction are described. In a typical purchase transaction, a user browses a vendor website and selects items to purchase. The user then proceeds to checkout screen 20 provided by vendor computer 13, shown in FIG. 2. In accordance with the principles of the present invention, the vendor offers the user an option to select Anonymous Shipping 22 by providing a button or a link in the screen display.

If the user selects the Anonymous Shipping option, the user clicks button 22. Responsive to activation of button 22, service provider computer 15 displays login window 24 on the user device if the user has not previously logged in, as shown in FIG. 3. The user logs in and authorizes the purchase. In accordance with the present invention, vendor computer 13 does not access or receive the user's personal information or the shipping address. Instead, billing and shipping are handled through service provider's computer 15, as described in detail hereinbelow.

After the transaction has been successfully processed, vendor computer 13 displays “thank you” message 26 on user device 12, as shown in FIG. 4.

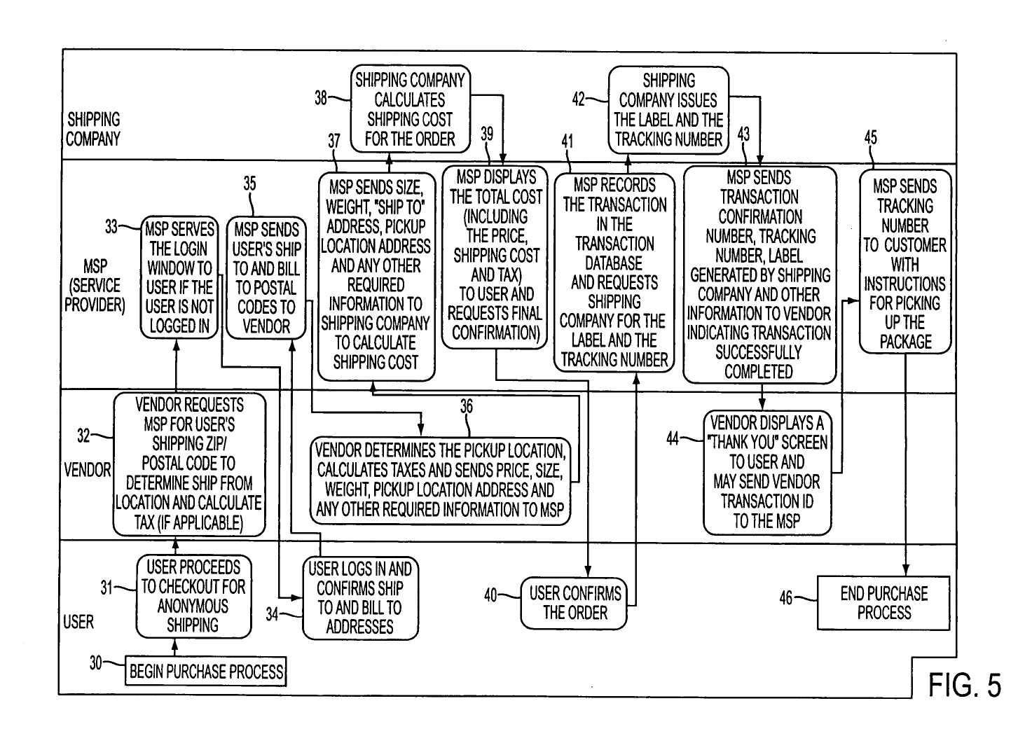

Referring now to FIG. 5, illustrative steps involved in using system 10 of the present invention to support a purchase transaction, such as shown in FIGS. 2-4, are described. Step 30 represents the beginning of a purchase process. After a user has selected one or more items to purchase, he or she proceeds to checkout in Step 30, corresponding to display 20 of FIG. 2. If the user elects anonymous shipping during the checkout process, Step 31, the vendor, at Step 32, requests the user's zip code from service provider computer 15 in order to determine the “ship from” location (in those cases where vendor has multiple locations from where it can ship) and for determining any applicable taxes (i.e., U.S. vendors are required to charge users sales tax in certain states). The service provider's computer 15 receives this request from vendor computer 13, and checks whether the user is already logged in, and if not, at Step 33, displays login window 23 (see FIG. 3) on user device 12.

At Step 34, the user logs in with his or her login id and password, service provider computer 15 validates the user information, and retrieves the user's zip code from the user database within the service provider database. Still at Step 34, the user confirms the “ship to” and “bill to” addresses and if allowed by the vendor and/or MSP, the user may also select a preferred shipping company. At step 35, service provider computer 15 sends the zip code information to vendor computer 13. Responsive to receipt of this information, at Step 36, vendor computer 13 determines the ship from location and calculates any applicable taxes and sends this information along with price of the purchased goods, size and weight of the package to service provider computer 15.

At Step 37, service provider computer 15 sends the size and weight of the package, and the pickup and drop off addresses, to shipping company's computer 14. Shipping company computer 14 calculates the shipping cost in Step 38 and returns the shipping cost information to service provider computer 15.

Alternatively, the shipping company may be agreed to between the service provider and the vendor, e.g., Federal Express or United Parcel Service, in which case vendor computer 13 already may be programmed with the applicable software for computing the shipping cost. As a further alternative, vendor computer 13 may be programmed to connect to the shipping company computer directly to determine the shipping cost. In either case, Steps 37 and 38 may be omitted, with vendor computer 13 providing service provider computer 15 all of the cost information needed for display to the user at Step 39.

As yet another alternative, the service provider may contract with a plurality of shipping companies, and service provider computer 15 already may be programmed with the applicable software for computing the shipping cost for each of the plurality of shipping companies. Service provider computer 15 may be programmed to compute the shipping cost for each of the plurality of shipping companies directly, and then select the shipping company that best meets the users shipping preferences, e.g., shortest shipping time or lowest shipping cost. In this case Step 38 may be omitted.

At Step 39, service provider computer 15 displays on user device 12 the total cost, including the sales price plus shipping cost and taxes. Service provided computer 15 then requests that the user confirm the proposed purchase.

At Step 40, user confirms the order and in Step 41, service provider computer 15 processes the transaction by debiting the user account with the total cost (sales price plus taxes and shipping cost), crediting the vendor account with the sales price less any service charge payable to the service provider by the vendor and crediting the shipping company's account with shipping cost less any service charge payable to the service provider by the shipping company. Service provider computer 15 also sends a request for the label and tracking number to shipping company computer 14.

At Step 42, shipping company computer issues the label and the tracking number and sends them, preferably electronically, to the service provider. At Step 43, service provider computer 15 sends a Transaction Confirmation Number, the shipping company's tracking number and the label to the vendor indicating that the transaction has been successfully processed. In accordance with the principles of the present invention, the shipping label contains no user information. Instead, the shipping label shows a “hold at” location where the shipping company will hold the package for the user. Upon receiving the tracking number, vendor computer 13, at Step 44, designates the items associated with the transaction for shipment and displays a “Thank you” screen on user device 12.

At Step 45, the service provider notifies the user via e-mail, through the website, or by any other suitable method, including mail or via telephone, that the transaction has been processed. The service provider also sends the tracking number and instructions for picking up the package from the “hold at” location of the shipping company. Step 46 denotes the end of purchase process.

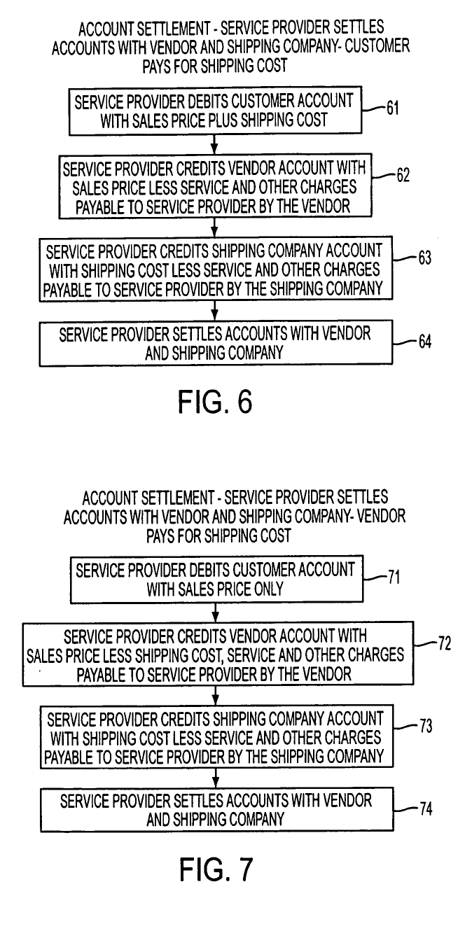

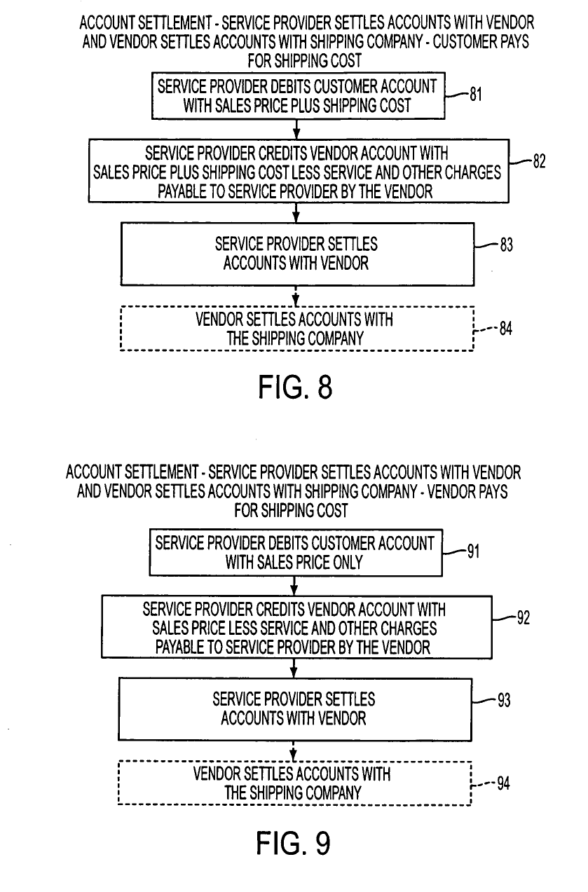

Referring now to FIGS. 6-9, illustrative methods for settling the vendor and shipping company accounts under a variety of payment arrangements are described. In the method of FIG. 6, the service provider settles accounts for the vendor and shipping company where the user pays for the shipping costs. FIG. 7 illustrates a similar arrangement, with the service provider settling accounts for the vendor and shipping company, but where the vendor pays for the shipping costs. In the method described with respect to FIG. 8, the user pays for the shipping costs, the service provider settles the account with the vendor, and the vendor settles the account with the shipping company. FIG. 9 illustrates a similar arrangement, but where the vendor, rather than the user, pays the shipping costs.

Referring again to FIGS. 6 and 7, the details of service provider computer 15 settling accounts with the vendor and shipping company, corresponding to Step 40 of FIG. 5, are described. Specifically, when the user confirms the purchase order at Step 40 of FIG. 5, the user's account balance is checked to determine whether the user has sufficient funds to cover the desired purchase. Information on the user's account balance may be maintained by service provider computer 15. If the user does not have sufficient funds, the user may be provided with an opportunity to deposit additional funds (e.g., by credit card, by transferring funds from another account, by using a check or cash deposit, etc.).

If the user is determined to have sufficient funds available to cover the proposed purchase, the user's account is debited the sales price plus shipping cost at Step 61 of FIG. 6. If the vendor is paying for the shipping cost then the user account is debited only the sales price, as shown at Step 71 of FIG. 7. The user's account balance information then may be updated on service provider computer 15.

At steps 62 and 72, respectively, service provider computer 15 credits the vendor's account. The vendor may receive a credit in the form of an addition of funds or credit into the vendor's account at service provider computer 15 or at a computer maintained at any other suitable facility. The service provider may levy a service charge or fee to a vendor for each purchase transaction that involves a transfer between the user's account and the vendor's account. In addition, the service provider may levy the vendor a monthly charge or other periodic charge. The foregoing are merely illustrative examples of charges and any other suitable scheme may be used by service provider computer 15 to levy or collect a service charge for handling transactions. In addition, the service charge may be debited to a vendor account maintained by service provider computer 15.

If the customer pays for the shipping costs, then at Step 62, service provider computer 15 credits the vendor for the sales price less any service charge or other charge payable by the vendor to the service provider. If the vendor pays for the shipping costs, then at Step 72 the amount credited to the vendor by service computer 15 will also be reduced by the amount of the shipping costs.

At steps 63 and 73, respectively, service provider computer 15 credits the shipping company's account for the shipping cost of each transaction. The shipping company may receive a credit in the form of an addition of funds or credit into the shipping company's account at service provider computer 15 or at a computer maintained at any other suitable facility. Similarly, the service provider may levy a service charge or fee to the shipping company for each transaction that involves shipping or may levy a monthly charge or other periodic charge. Once again the foregoing charges are merely illustrative, and any other suitable scheme may be used by service provider computer 15 to levy or collect a service charge for handling transactions. The service charge also may be debited to a shipping company account maintained by service provider computer 15.

Records of the debiting and crediting activities between accounts that are associated with each purchase transaction may be maintained by service provider computer 15. Vendor and shipping company's accounts may be reconciled on a per transaction basis in real-time or may be periodically settled (e.g., once per day, once per month, or according to any other suitable predetermined schedule or a combination of both) as shown in steps 64 and 74, respectively.

Referring now to FIGS. 8 and 9, illustrative steps are described for transaction processing in which the service provider settles accounts with the vendor and the vendor then settles accounts with the shipping company.

In the method of FIG. 8, the customer pays the shipping costs while in the method of FIG. 9 the vendor pays the shipping costs. Accordingly, for the method of FIG. 8, service provider computer 15 debits the user's account with the sales price plus the shipping cost at Step 81 (corresponding to Step 40 of FIG. 5), while for the method of FIG. 9, the user account is debited only for the sales price at Step 91 (again corresponding to Step 40 of FIG. 5).

At Step 82 of FIG. 8, the service provider computer credits the vendor account with sales price plus the shipping cost less any service charges that is payable by the vendor to the service provider. Here, the vendor account is credited with the shipping cost because it is the vendor that will settle accounts with the shipping company, at Step 83. At corresponding Step 92 of FIG. 9, the service provider computer credits the vendor account only for the sales prices less any service charges payable by the vendor to the service provider, as described hereinabove.

At Steps 83 and 93, respectively, the service provider settles accounts with the vendor. At steps 84 and 94, respectively, vendor settles accounts with the shipping company directly.

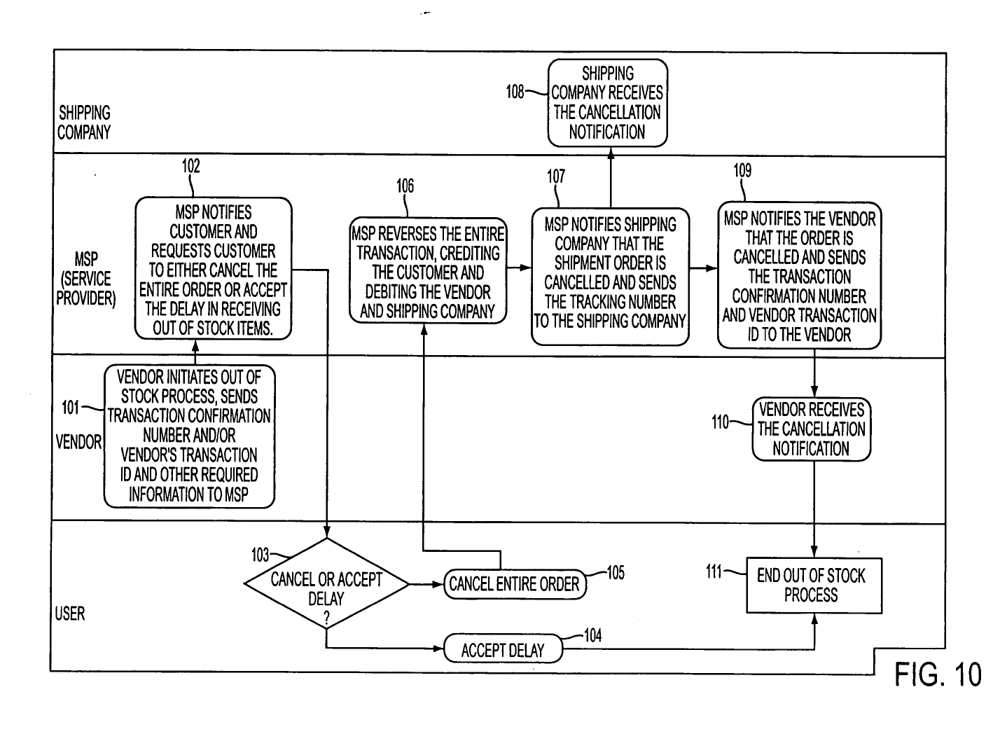

Referring now to FIG. 10, illustrative steps are described for using system 10 of the present invention to enable a vendor deal with an out-of-stock situation for either an entire or part of an order. In such a case the vendor needs to alert the user that the requested item or service is unavailable, and give the user an option to either cancel the entire order or accept the delay in the shipment. Since the user's identity and location are not known to the vendor, this process must be handled through service provider computer 15.

At Step 101, vendor computer 13 initiates the out-of-stock process by sending either or both of the Transaction Confirmation number and the Vendor's Transaction ID, and any other required information, to service provider computer 15.

At Step 102, service provider computer 15 sends a notification to the user and requests the user either to cancel the entire order or accept a delay in receiving out-of-stock items. At step 103, user elects either to cancel the entire order or accept a delay in receiving items that are out-of-stock. If the user decides to accept the delay, he or she informs service provider computer 15 at Step 104, and that the out-of-stock-process concludes at Step 111.

If the user decides to cancel the entire order, he or she so informs the service provider at Step 105. In this latter case, the service provider reverses the original transaction by crediting the user and debiting the vendor and the shipping company, at Step 106. At step 107, service provider computer 15 informs the shipping company that the order is cancelled and sends this notification with the tracking number that was issued by shipping company computer 14 when the original transaction was processed. At step 107, the shipping company receives the cancellation notice.

At step 109, service provider computer 15 notifies the vendor that the user has cancelled the entire order and sends this notification with either or both the original Transaction Confirmation Number or the Vendor Transaction ID. At step 110, the vendor receives this notification, with the out-of-stock process concluding at Step 111.

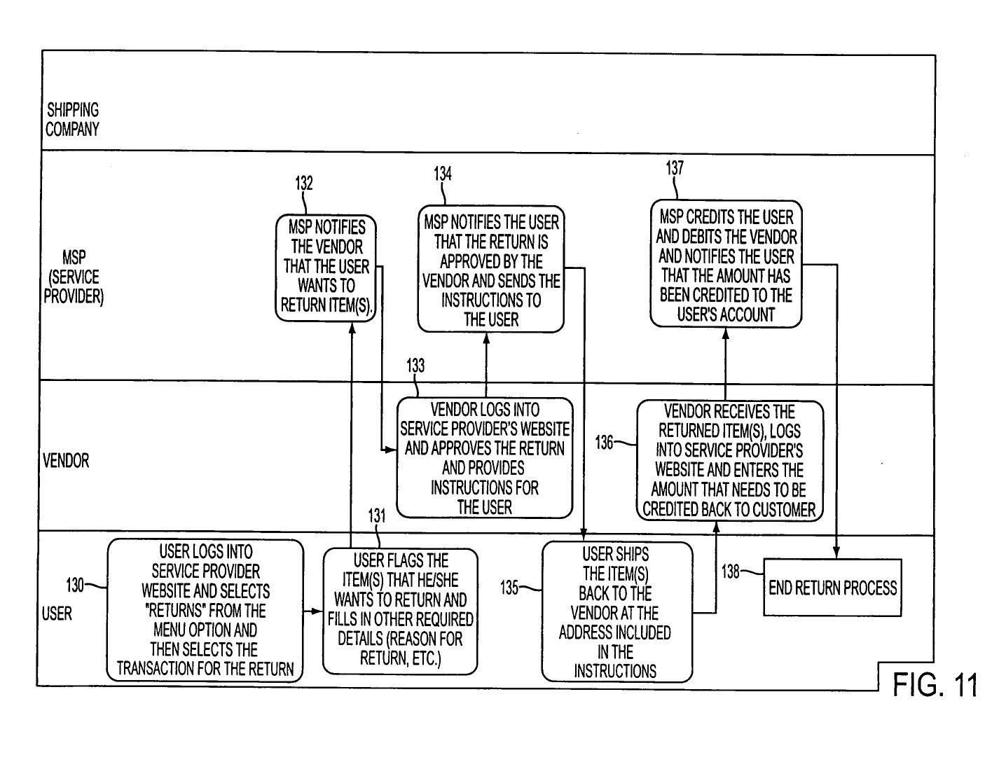

With respect to FIG. 11, illustrative steps are described for using system 10 of the present invention to enable a user to return goods to the vendor without disclosing any personal information to the vendor. In step 130, the user logs-on to his or her account at the service provider's website and proceeds to a “Disputes and Returns” screen. In a preferred embodiment, the “Disputes and Returns” screen displays all, or the most recent, transactions with vendors handled through service provider's computer 15. The user then selects the transaction that was created when he or she purchased the product.

At step 131, the user selects the items that he or she wants to return and provides any other information required by the service provider for processing the return of goods. At step 132, the service provider notifies the vendor that the user wants to return items. This notification may be sent electronically via e-mail, through a batch process, or through any other suitable communication path established between the service provider and the vendor for such notifications.

Responsive to the notification by service provider computer 15, the vendor logs into the service provider website at Step 133, and retrieves the record regarding the return transaction from service provider computer 15. Still at Step 133, if the vendor approves the return, the vendor provides instructions for the user to send the item(s) back to the vendor. The cost of shipping the returned goods may be borne either by the user or the vendor, as determined by the sales contract associated with the original purchase transaction. At step 134, the service provider sends this notification, along with the instructions for shipping the items to be returned, to the user.

At step 135, the user ships the item(s) back to the vendor. At step 136, the vendor receives the returned item(s), logs-on to the service provider website, and enters the amount to be returned to the user. At step 137, service provider computer 15 debits the vendor account and credits the user's account. Because the shipping costs are borne either by the vendor or the user as part of the original transaction, this process creates neither a credit nor a debit to the shipping company's account maintained by service provider computer 15 of vendor computer 13. The return of goods process then concludes at Step 138.

The foregoing written description is merely illustrative of the principles of this invention and various modifications can be made by those skilled in the art without departing from the scope and spirit of the invention.

What is claimed is:

1. A system for facilitating electronic commerce among users, a service provider and vendors, wherein each user has established an account with the service provider but the vendors do not have access to the identity or address of the user, the system comprising:
one or more vendor computers, each vendor computer programmed to provide a website at which a user at a user device may purchase an item for anonymous shipping;
a service provider computer at which the user has established an account, the service provider computer programmed to accept purchase information from a vendor computer, to provide shipping instructions to the vendor computer, and to settle an account with the vendor for purchase of the item, without identifying an identity or address of the user; and
a communications network enabling the user device to communicate with the one or more vendor computers and the service provider computer.

2. The system of claim 1 wherein the service provider computer is programmed to:
debit the user's account by the purchase price and shipping cost when the user purchases the item from the vendor; and
credit the vendor by the purchase price less any charge to the service provider using funds from the user's account.

3. The system of claim 1 wherein the service provider computer further comprises programming to credit a shipping company by the shipping cost using funds from the user's account.

4. The system of claim 1 wherein the shipping instructions provided by the service provider computer include a ship-from location and ship-to location.

5. The system of claim 1 wherein the service provider computer further comprises programming to debit the user account by the shipping cost if the user is required to pay the shipping cost.

6. The system of claim 1 wherein the service provider computer further comprises programming to credit vendor account either on a transaction basis or on a periodic basis.

7. The system of claim 1 wherein the service provider computer further comprises a database that contains information about users, vendors and shipping companies.

8. The system of claim 1 wherein the service provider further comprises programming to display on the user device a total cost including the total sales price of the item purchased plus shipping costs and which requests user confirmation for the purchase.

9. The system of claim 1 wherein service provider further comprises programming for responding to an out-of-stock notification from the vendor by seeking confirmation by the user either to cancel the purchase or accept delay in the shipment of the item.

10. The system of claim 1 wherein the service provider computer further comprises programming for responding to a request for return notification from the user by seeking approval from the vendor, and if approval is granted, providing return shipping instructions from the vendor to the user.

11. A method for a vendor to conduct electronic commerce among a user, a service provider and the vendor, wherein the user has established an account with the service provider but the vendor does not have access to the identity or address of the user, the method comprising:
providing a website, associated with the vendor, at which a user may identify an item for purchase and anonymous shipping;
upon the user selecting an anonymous shipping option, directing the user to a computer associated with the service provider;
receiving shipping instructions from the service provider that do not disclose the identity or address of the user;
designating the item for shipment in accordance with the shipping instructions; and
accepting payment from the service provider.

12. The method of claim 11 wherein the vendor has more than one ship-from location, the method further comprising:
retrieving from the service provider a postal code associated with the user; and
based on the postal code retrieved from the service provider, determining a location from which the item should be shipped.

13. The method of claim 11 wherein, prior to receipt of the shipping instructions from the service provider, the vendor computes a total sales price for the item, excluding shipping costs.

14. The method of claim 13 wherein, following computation of the total sales price, the total sales price is communicated to the service provider.

15. The method of claim 11 wherein, prior to receipt of the shipping instructions from the service provider, the vendor computes a total sales price for the item, including shipping costs.

16. The method of claim 15 wherein, following computation of the total sales price, the total sales price is communicated to the service provider.

17. The method of claim 11 further comprising, after designating the item for shipment in accordance with the shipping instructions, notifying the user of the expected date of delivery.

18. The method of claim 11 further comprising, after accepting payment from the service provider, crediting shipping costs for the item to a shipping company.

19. The method of claim 11 further comprising, if the vendor determines that the item is out of stock,
notifying the service provider that the item is out of stock; and
if the user elects to cancel purchase of the item, receiving instructions from the service provider to cancel shipment of the item.

20. The method of claim 11 further comprising, if the user elects to return the item after delivery,
receiving a notification from the service provider that the user wants to return the item;
reviewing a transaction record of the service provider to confirm that return of the item is permissible, and if so, approving return of the item;
providing return shipping instructions to the service provider for transmission to the user;
receiving the item returned by the user; and
updating the transaction record of the service provider to credit the user for the returned item.

21. A method for a service provider to facilitate electronic commerce among a user, the service provider and a vendor, wherein the user has established an account with the service provider but the vendor does not have access to the identity or address of the user, the method comprising:
providing a website with which vendors may register to sell goods and services to registered users of the service provider, each vendor having a website at which users may identify items for purchase and anonymous shipping;
upon a user selecting an item for purchase with an anonymous shipping option at one of vendors' websites, enabling the user log-on to a computer associated with the service provider;
obtaining a shipping cost for the item and a total sales price from the vendor;
creating a transaction record in which the vendor is credited for the total sales price less any service charge due to the service provider;
providing shipping instructions to the vendor that do not disclose the identity or address of the user; and
providing pick-up instructions to the user.

22. The method of claim 21 wherein, if a vendor has more than one ship-from location, further comprising:
providing a postal code associated with the user to the vendor; and
receiving from the vendor a location from which the item should be shipped.

23. The method of claim 21 wherein obtaining a shipping cost for the item further comprises:
receiving a description of the item from the vendor; and
sending the description, a ship-from location and a ship-to location to a shipping company; and
receiving from the shipping company a shipping cost.

24. The method of claim 23 wherein, after obtaining the shipping cost for the item and the total sales price from the vendor, the shipping cost and total sales price are communicated to the user.

25. The method of claim 21 wherein obtaining a shipping cost for the item further comprises:
receiving a description of the item from the vendor; and
computing a shipping cost for a plurality of shipping companies based on the description, a ship-from location and a ship-to location; and
selecting a shipping company for use in shipping the item based on a predetermined user preference.

26. The method of claim 25 wherein, after obtaining the shipping cost for the item and the total sales price from the vendor, the shipping cost and total sales price are communicated to the user.

27. The method of claim 21 wherein, in creating the transaction record, the shipping company is credited for the shipping cost.

28. The method of claim 21 wherein, before the transaction record is created, the service provider receives confirmation from the user that the user desires to proceed with purchase and anonymous shipping of the item.

29. The method of claim 21 further comprising, if the vendor determines that the item is out of stock,
receiving a notification from the vendor that the item is out of stock; and
providing the user with a notification requesting that the user either accept a delay in shipment of the item or cancel purchase of the item; and
if the user elects to cancel purchase of the item, notifying the vendor to cancel shipment of the item.

30. The method of claim 21 further comprising, if the user elects to return the item after delivery,
sending a notification to the vendor that the user wants to return the item;
providing the vendor access to the transaction record to enable the vendor to review and approve return of the item;
receiving return shipping instructions from the vendor; and
notifying the user that return of the item is approved and providing return shipping instructions; and
once the vendor confirms receipt of the item returned by the user, updating the transaction record to credit the user and debit the vendor for the returned item.
